(19) United States
(12) Patent Application Publication
(10) Pub. No.: US 2022/0014518 A1
(43) Pub. Date: Jan. 13, 2022

(54) SYSTEM TO CONFIRM IDENTITY OF CANDIDATES

(71) Applicant: NCS Pearson, Inc., Bloomington, MN (US)

(72) Inventors: Joseph BRUTSCHE, Bloomington, MN (US); Sara-Jane DICKINSON, Manchester (GB); Bryan FRIESS, Woodbury, MN (US); Michael NEALIS, St. Charles, IL (US)

(21) Appl. No.: 16/922,682

(22) Filed: Jul. 7, 2020

(51) Int. Cl. H04L 29/06; G06F 16/635; G06F 16/683; G06N 20/00; G10L 17/22

(52) U.S. Cl. CPC H04L 63/0861; G06F 16/636; G10L 17/22; G06N 20/00; G06F 16/683

(57) ABSTRACT

Systems and methods of the present invention provide for at least one processor executing program code instructions on a server computer coupled to a network. The program code instructions cause the server computer to receive from a user client an assessment audio file. The instructions also cause the computer to extract a plurality of audio features from the assessment audio file using a voice profile module. In addition, the instructions cause the computer to store the assessment audio file and extracted features in a database. Further, the instructions cause the computer to calculate a candidate confidence score indicating the probability that the assessment audio file is from a common speaker as a previously stored audio file within the database. Lastly, the instructions cause the computer to generate a based on the candidate confidence score.

### FIELD OF THE INVENTION

This disclosure relates to the field of systems and methods configured to determine test candidate identification consistency at least partially based on auditory detection.

### SUMMARY OF THE INVENTION

The present disclosure provides systems and methods comprising one or more server hardware computing devices or client hardware computing devices, communicatively coupled to a network, and each comprising at least one processor executing specific computer-executable instructions within a memory that, when executed, cause the system to:

In an embodiment, a system includes at least one processor executing program code instructions on a server computer coupled to a network, the program code instructions causing the server computer to receive from a user client device an assessment audio file, extract a plurality of audio features from the assessment audio file using a voice profile module, wherein the audio features are extracted through at least one of an acoustic model, a language model, and a pronunciation dictionary, store the assessment audio file and extracted features in a database, calculate, through a scoring module, a candidate confidence score indicating a probability that the assessment audio file is from a common speaker as a previously stored audio file within the database, and generate a first notification when the candidate confidence score is above a first threshold or a second notification when the candidate confidence score is less than a second threshold, wherein the first and second thresholds are predefined probability metrics and the second threshold is lower than the first threshold.

In another embodiment, a method for at least one processor executing program code instructions on a server computer coupled to a network includes receiving an assessment audio file from a user client device, determining a plurality of features from the assessment audio file through a voice profile module, applying the features to a scoring module comprising a machine learning engine to calculate a candidate confidence score indicating a probability that two audio files are recorded from a common speaker and a proxy confidence score indicating a probability that the two audio files are from two different speakers, comparing the candidate confidence score to a first threshold and a second threshold, wherein the first and second thresholds are predefined probability metrics, and generating a first notification when the candidate confidence score is greater than the first threshold and a second notification when the candidate confidence score is less than the second threshold.

In another embodiment, a system includes a processor and a memory coupled to the processor. The memory stores program instructions executable by the processor to perform receiving an assessment audio file, determining a plurality of features from the assessment audio file through a voice profile module, applying the features to a scoring module, receiving from the scoring module a candidate confidence score and a proxy confidence score, and storing the assessment audio file in a proxy data set when the candidate confidence score is below a proxy threshold.

The above features and advantages of the present disclosure will be better understood from the following detailed description taken in conjunction with the accompanying drawings.

### BRIEF DESCRIPTION OF THE DRAWINGS

FIG. 1 illustrates a system level block diagram for a non-limiting example of a distributed computing environment, according to some embodiments.

FIG. 2 illustrates a system level block diagram for an illustrative computer system, according to some embodiments.

FIG. 3 is a system that is configured to detect various features of an assessment audio file and store the features within a database, according to some embodiments.

FIG. 4 illustrates a system with a user client device that may create/record and then transmit an assessment audio file to the system, wherein the system is then able to evaluate the assessment audio file to determine a probability of a common speaker between various assessment audio files, according to some embodiments.

FIGS. 5 and 6 are flowcharts of various methods of practicing the invention to determine confidence scores of a common speaker between various assessment audio files and provide outputs based on the confidence scores, according to various embodiments.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

The content of standardized tests is generally highly protected, and as such, examination candidates are prevented from copying or removing the test material from the examination testing location. To circumvent these protections, examination proxies may participate in examinations with the sole purpose of memorizing testing material for removal from the examination testing sites. As used herein, “proxies” or “proxy candidate(s)” are persons who may be posing as someone other than their true identity or persons taking an examination for any reason other than the intended purpose of the examination. These professional proxies may be present at each offering of an examination, and may use fake identification or hide among the general population of examination test candidates to avoid detection. The material removed from the testing location can later be used to help legitimate examination candidates prepare for exams by familiarizing them with actual test questions and answer choices.

Another method of illicitly improving test scores exists such that an individual may have an examination proxy sit for the examination in the candidate's place, and thereby have the examination test candidate's results attributed to the candidate. The examination proxy may present the candidate's identification information as their own to have their testing results attributed to the individual. In addition, the examination proxy may present fake identification information bearing the picture of the examination proxy but other identification information, such as the name and address, of the candidate.

To assist in determining that a candidate's identity has not changed during an examination event, speech recognition may be utilized. In some instances, the candidate may have their speech recorded and stored in a database. A subsequent audio recording from the same candidate captured during an examination event may be compared to the previously recorded and stored audio file for identity authentication. In some examples, each of the assessment audio files may additionally or alternatively be compared to stored assessment audio files of known proxies known proxy candidates. To authenticate an identity of a candidate, a confidence score may be generated between various audio files and/or data points with the assistance of a system that utilizes automatic speech recognition technology. The confidence score is a probability metric that two audio files were recorded from a common speaker.

In some instances, the system may include a voice profile module, a database, and a scoring module. The voice profile module is configured to extract one or more features from the assessment audio file. The extracted features and the assessment audio file are stored in the database, which may be cataloged in any manner. For example, the database may include one or more data sets. In some instances, one data set may include candidate audio data, a second data set may include proxy audio data, and a third data set may include training data for the scoring module.

The scoring module is configured to calculate a confidence score, which is a probability that two audio files are recorded from a common speaker. In operation, the scoring module is configured to calculate a confidence score using any practicable score-generation algorithm. The score-generation algorithm “learns” how to score the likelihood that two audio files were recorded from a common speaker through comparative analysis and predictions of similar features, which may be further refined through iterative comparative analysis of the features and weighting of various extracted features. The scoring module may output a candidate confidence score, a proxy confidence score, and/or any other type of confidence score. Each confidence score is a representative probability quantified as a number between 0 and 1 in which 0 indicates impossibility and 1 indicates certainty that two files are from a common speaker. The higher the confidence score, or probability, the more likely that two audio files are from a common speaker.

Once the scoring module generates the candidate confidence score and/or the proxy confidence score, the confidence scores may be compared to one another and/or to one or more thresholds. When the candidate confidence score and the proxy confidence score are compared to one another, a notification of the greater score may be outputted to a user client device. In instances in which the candidate confidence score is higher than the proxy confidence score, it is more likely that the assessment audio file is recorded from a candidate or legitimate, identified candidate. In instances in which the proxy confidence score is greater than a candidate confidence score, it is more likely that the assessment audio file is not recorded from the person claiming to be the candidate. In some examples, when the candidate confidence score is greater than the proxy confidence score a first notification, such as a pass or confirmation notification, is provided to the user client device. In some examples, when the proxy confidence score is greater than the candidate confidence score, a second notification, such as a fail or unconfirmed identity notification, may be provided to the user client device.

In some instances, the system may include predefined thresholds for determining whether a confidence score is high enough to deem that the two audio files are from a common speaker. For example, a first predefined threshold of 0.8 indicating a predicted 80% probability that the two audio files are from a common speaker may be set. A second threshold of 0.6 may be defined indicating a less likely chance that the two audio files are from a common speaker. Once the scoring module generates the various confidence scores, the confidence scores may be compared to the thresholds to dictate which scores generate a pass notification indicating the two files are from a common speaker or a fail notification indicating that the likelihood of a common speaker between two audio files is below a predefined probability. Any number of thresholds may be defined at any probability for assisting in determine when to generate a pass or a fail notification.

In addition, each assessment audio file and the extracted features thereof may be stored in the database. Each assessment audio file may be compared to every stored audio file in the database or various portions thereof. For example, in some instances, each assessment audio file may be compared to any and all of the stored audio files or to specific audio files that are recorded from an alleged common speaker. Additionally or alternatively, each assessment audio file may be compared to a data set of audio files including recordings from known proxies. The data set of audio files for known proxies may include the extracted features of each associated audio file and various characteristics of the proxy, including but not limited to, the recording locations of the proxy, sex, hair color, eye color, and so on. When the scoring module deems that there is a fair probability that the assessment audio file may have been recorded from a known proxy, the various characteristics can further confirm the identity of the speaker.

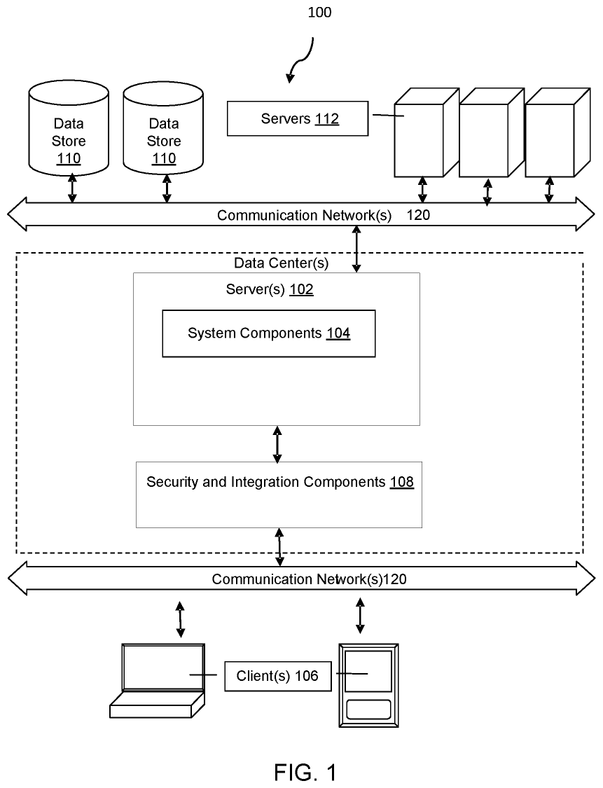

FIG. 1 illustrates a non-limiting example of a distributed computing environment 100, which includes one or more computer server computing devices 102, one or more client computing devices 106, and other components that may implement certain embodiments and features described herein. Other devices, such as specialized sensor devices, etc., may interact with the client 106 and/or the server 102. The server 102, the client 106, or any other devices may be configured to implement a client-server model or any other distributed computing architecture.

The server 102, the client 106, and any other disclosed devices may be communicatively coupled via one or more communication networks 120. The communication network 120 may be any type of network known in the art supporting data communications. As non-limiting examples, the network 120 may be a local area network (LAN; e.g., Ethernet, Token-Ring, etc.), a wide-area network (e.g., the Internet), an infrared or wireless network, a public switched telephone networks (PSTNs), a virtual network, etc. The network 120 may use any available protocols, such as (e.g., transmission control protocol/Internet protocol (TCP/IP), systems network architecture (SNA), Internet packet exchange (IPX), Secure Sockets Layer (SSL), Transport Layer Security (TLS), Hypertext Transfer Protocol (HTTP), Secure Hypertext Transfer Protocol (HTTPS), Institute of Electrical and Electronics (IEEE) 802.11 protocol suite or other wireless protocols, and the like.

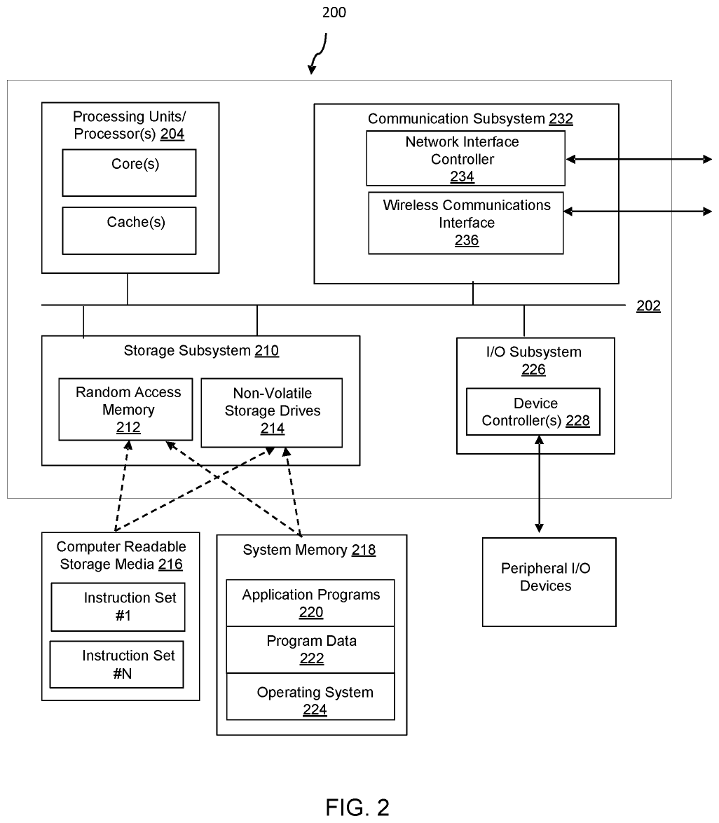

The embodiments shown in FIGS. 1-2 are thus one example of a distributed computing system and is not intended to be limiting. The subsystems and components within the server 102 and the client devices 106 may be implemented in hardware, firmware, software, or combinations thereof. Various different subsystems and/or components 104 may be implemented on the server 102. Users operating the client devices 106 may initiate one or more client applications to use services provided by these subsystems and components. Various different system configurations are possible in different distributed computing systems 100 and content distribution networks. The server 102 may be configured to run one or more server software applications or services, for example, web-based or cloud-based services, to support content distribution and interaction with the client devices 106. Users operating the client devices 106 may, in turn, utilize one or more client applications (e.g., virtual client applications) to interact with the server 102 to utilize the services provided by these components. The client devices 106 may be configured to receive and execute client applications over the one or more networks 120. Such client applications may be web browser-based applications and/or standalone software applications, such as mobile device applications. The client devices 106 may receive client applications from the server 102 or from other application providers (e.g., public or private application stores).

As shown in FIG. 1, various security and integration components 108 may be used to manage communications over the network 120 (e.g., a file-based integration scheme or a service-based integration scheme). Security and integration components 108 may implement various security features for data transmission and storage, such as authenticating users or restricting access to unknown or unauthorized users.

As non-limiting examples, the security components 108 may comprise dedicated hardware, specialized networking components, and/or software (e.g., web servers, authentication servers, firewalls, routers, gateways, load balancers, etc.) within one or more data centers in one or more physical location and/or operated by one or more entities, and/or may be operated within a cloud infrastructure.

In various implementations, the security and integration components 108 may transmit data between the various devices in the content distribution network 100. The security and integration components 108 also may use secure data transmission protocols and/or encryption (e.g., File Transfer Protocol (FTP), Secure File Transfer Protocol (SFTP), and/or Pretty Good Privacy (PGP) encryption) for data transfers, etc.).

In some embodiments, the security and integration components 108 may implement one or more web services (e.g., cross-domain and/or cross-platform web services) within the content distribution network 100, and may be developed for enterprise use in accordance with various web service standards (e.g., the Web Service Interoperability (WS-I) guidelines). For example, some web services may provide secure connections, authentication, and/or confidentiality throughout the network using technologies such as SSL, TLS, HTTP, HTTPS, WS-Security standard (providing secure SOAP messages using XML encryption), etc. In other examples, the security and integration components 108 may include specialized hardware, network appliances, and the like (e.g., hardware-accelerated SSL and HTTPS), possibly installed and configured between the servers 102 and other network components, for providing secure web services, thereby allowing any external devices to communicate directly with the specialized hardware, network appliances, etc.

The computing environment 100 also may include one or more data stores 110, possibly including and/or residing on one or more back-end servers 112, operating in one or more data centers in one or more physical locations, and communicating with one or more other devices within the one or more networks 120. In some cases, the one or more data stores 110 may reside on a non-transitory storage medium within the server 102. In certain embodiments, the data stores 110 and the back-end servers 112 may reside in a storage-area network (SAN). Access to the data stores may be limited or denied based on the processes, user credentials, and/or devices attempting to interact with the data store.

With reference now to FIG. 2, a block diagram of an illustrative computer system is shown. The system 200 may correspond to any of the computing devices or servers of the network 100, or any other computing devices described herein. In this example, computer system 200 includes processors 204 that communicate with a number of peripheral subsystems via a bus subsystem 202. These peripheral subsystems include, for example, a storage subsystem 210, an I/O subsystem 226, and a communications subsystem 232.

One or more processors 204 may be implemented as one or more integrated circuits (e.g., a conventional microprocessor or microcontroller), and controls the operation of the computer system 200. These processors may include single core and/or multicore (e.g., quad-core, hexa-core, octo-core, ten-core, etc.) processors and processor caches. The processors 204 may execute a variety of resident software processes embodied in program code, and may maintain multiple concurrently executing programs or processes. The processor(s) 204 may also include one or more specialized processors, (e.g., digital signal processors (DSPs), outboard, graphics application-specific, and/or other processors).

The bus subsystem 202 provides a mechanism for intended communication between the various components and subsystems of the computer system 200. Although the bus subsystem 202 is shown schematically as a single bus, alternative embodiments of the bus subsystem may utilize multiple buses. The bus subsystem 202 may include a memory bus, memory controller, peripheral bus, and/or local bus using any of a variety of bus architectures (e.g. Industry Standard Architecture (ISA), Micro Channel Architecture (MCA), Enhanced ISA (EISA), Video Electronics Standards Association (VESA), and/or Peripheral Component Interconnect (PCI) bus, possibly implemented as a Mezzanine bus manufactured to the IEEE P1386.1 standard).

The I/O subsystem 226 may include device controllers 228 for one or more user interface input devices and/or user interface output devices, possibly integrated with the computer system 200 (e.g., integrated audio/video systems, and/or touchscreen displays), or may be separate peripheral devices which are attachable/detachable from the computer system 200. The input may include keyboard or mouse input, audio input (e.g., spoken commands), motion sensing, gesture recognition (e.g., eye gestures), etc.

As non-limiting examples, input devices may include a keyboard, pointing devices (e.g., mouse, trackball, and associated input), touchpads, touch screens, scroll wheels, click wheels, dials, buttons, switches, keypad, audio input devices, voice command recognition systems, microphones, three dimensional (3D) mice, joysticks, pointing sticks, gamepads, graphic tablets, speakers, digital cameras, digital camcorders, portable media players, webcams, image scanners, fingerprint scanners, barcode readers, 3D scanners, 3D printers, laser rangefinders, eye gaze tracking devices, medical imaging input devices, MIDI keyboards, digital musical instruments, and the like.

In general, use of the term “output device” is intended to include all possible types of devices and mechanisms for outputting information from computer system 200 to a user or other computer. For example, output devices may include one or more display subsystems and/or display devices that visually convey text, graphics and audio/video information (e.g., cathode ray tube (CRT) displays, flat-panel devices, liquid crystal display (LCD) or plasma display devices, projection devices, touch screens, etc.), and/or non-visual displays such as audio output devices, etc. As non-limiting examples, output devices may include, indicator lights, monitors, printers, speakers, headphones, automotive navigation systems, plotters, voice output devices, modems, etc.

The computer system 200 may comprise one or more storage subsystems 210, including hardware and software components used for storing data and program instructions, such as a system memory 218 and a computer-readable storage media 216.

The system memory 218 and/or computer-readable storage media 216 may store program instructions that are loadable and executable on the processor(s) 204. For example, the system memory 218 may load and execute an operating system 224, program data 222, server applications, client applications 220, Internet browsers, mid-tier applications, etc.

The system memory 218 may further store data generated during the execution of these instructions. The system memory 218 may be stored in volatile memory (e.g., random access memory (RAM) 212, including static random access memory (SRAM) or dynamic random access memory (DRAM)). The RAM 212 may contain data and/or program modules that are immediately accessible to and/or operated and executed by the processors 204.

The system memory 218 may also be stored in non-volatile the storage drives 214 (e.g., read-only memory (ROM), flash memory, etc.) For example, a basic input/output system (BIOS), containing the basic routines that help to transfer information between elements within the computer system 200 (e.g., during start-up) may typically be stored in the non-volatile storage drives 214.

The storage subsystem 210 also may include one or more tangible computer-readable storage media 216 for storing the basic programming and data constructs that provide the functionality of some embodiments. For example, the storage subsystem 210 may include software, programs, code modules, instructions, etc., that may be executed by a processor 204, in order to provide the functionality described herein. Data generated from the executed software, programs, code, modules, or instructions may be stored within a data storage repository within the storage subsystem 210.

The storage subsystem 210 may also include a computer-readable storage media reader connected to the computer-readable storage media 216. The computer-readable storage media 216 may contain program code, or portions of program code. Together and, optionally, in combination with the system memory 218, the computer-readable storage media 216 may comprehensively represent remote, local, fixed, and/or removable storage devices plus storage media for temporarily and/or more permanently containing, storing, transmitting, and retrieving computer-readable information.

The computer-readable storage media 216 may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible COMPUTER-READABLE media. This can also include nontangible computer-readable media, such as data signals, data transmissions, or any other medium which can be used to transmit the desired information and which can be accessed by the computer system 200.

By way of example, the computer-readable storage media 216 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 216 may include, but is not limited to, Zip® drives, flash memory cards, universal serial bus (USB) flash drives, secure digital (SD) cards, DVD disks, digital video tape, and the like. Computer-readable storage media 216 may also include, solid-state drives (SSD) based on non-volatile memory such as flash memory based SSDs, enterprise flash drives, solid state ROM, and the like, SSDs based on volatile memory such as solid state RAM, dynamic RAM, static RAM, DRAM-based SSDs, magneto-resistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 200.

The communications subsystem 232 may provide a communication interface from the computer system 200 and external computing devices via one or more communication networks, including local area networks (LANs), wide area networks (WANs) (e.g., the Internet), and various wireless telecommunications networks. As illustrated in FIG. 2, the communications subsystem 232 may include, for example, one or more network interface controllers (NICs) 234, such as Ethernet cards, Asynchronous Transfer Mode NICs, Token Ring NICs, and the like, as well as one or more wireless communications interfaces 236, such as wireless network interface controllers (WNICs), wireless network adapters, and the like. Wireless communications interfaces 236 may be configured to implement WIFI or cellular wireless communications, as needed. Additionally and/or alternatively, the communications subsystem 232 may include one or more modems (telephone, satellite, cellular, cable, ISDN), synchronous or asynchronous digital subscriber line (DSL) units, Fire Wire® interfaces, USB® interfaces, and the like. The communications subsystem 236 also may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.11 family standards, or other mobile communication technologies, or any combination thereof), global positioning system (GPS) receiver components, and/or other components.

In some embodiments, the communications subsystem 232 may also receive input communication in the form of structured and/or unstructured data feeds, event streams, event updates, and the like, on behalf of one or more users who may use or access the computer system 200. For example, the communications subsystem 232 may be configured to receive data feeds in real-time from users of social networks and/or other communication services, web feeds such as Rich Site Summary (RSS) feeds, and/or real-time updates from one or more third party information sources (e.g., data aggregators). Additionally, the communications subsystem 232 may be configured to receive data in the form of continuous data streams, which may include event streams of real-time events and/or event updates (e.g., sensor data applications, financial tickers, network performance measuring tools, clickstream analysis tools, automobile traffic monitoring, etc.). The communications subsystem 232 may output such structured and/or unstructured data feeds, event streams, event updates, and the like to one or more data stores that may be in communication with one or more streaming data source computers coupled to the computer system 200.

The various physical components of the communications subsystem 232 may be detachable components coupled to the computer system 200 via a computer network, a FireWire® bus, or the like, and/or may be physically integrated onto a motherboard of the computer system 200. The communications subsystem 232 also may be implemented in whole or in part by software.

Due to the ever-changing nature of computers and networks, the description of the computer system 200 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

The preparation of various examinations requires numerous hours and generally reflects copyrighted material owned by examination providers. As such, much time and effort is spent ensuring the integrity of an examination. Candidates must be properly registered to guarantee that only those persons who are qualified are registered to take the examination. It is also important to ensure that only persons who are registered are allowed to take the examination. The integrity of any test is damaged, of course, if tests are taken by persons other than those who are properly registered.

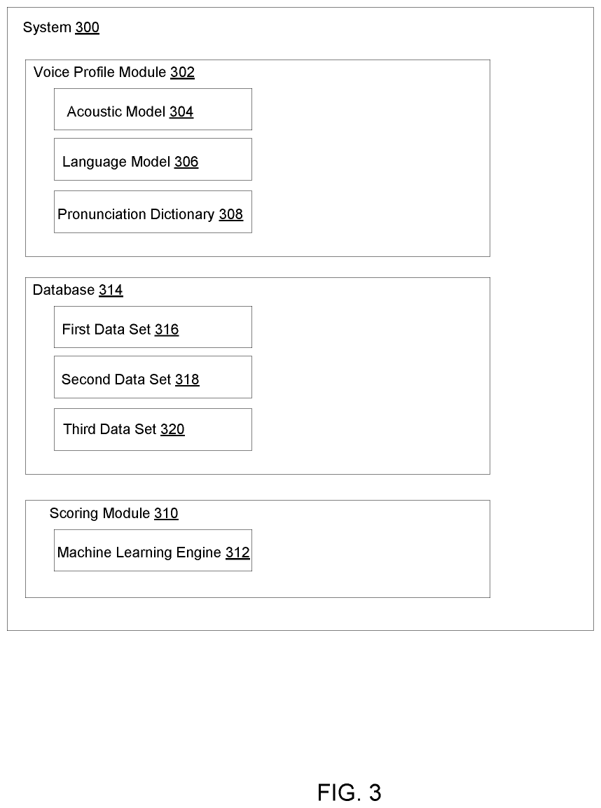

When a system is used with automatic speech recognition technology for assessing speech characteristics, broadly speaking, there can be one or more underlying components to perform the task. For example, with respect to FIGS. 2 and 3, a system 300 includes a processor, such as the processor 204 described in FIG. 2, that communicates with a number of peripheral subsystems via a bus subsystem 202 (FIG. 2). The bus subsystem 202 provides a mechanism for intended communication between the various components and subsystems of the system 300. For example, the bus subsystem may allow for communication between a voice profile module 302 that utilizes automatic speech recognition, a database, a scoring module, and any other practicable component. The system 300 may be implemented by any suitable computing system and may be a computer server system remote from the candidate (e.g., implemented within a cloud-based computing system). Alternatively, in some embodiments, system 300 may be local to the candidate and could be implemented by the computer system used by the candidate, for example, to undertake a testing activity.

The voice profile module is configured to receive various audio files and extract features from the audio file. The extraction of audio features may occur through any practicable process or model. For example, the voice profile module 302 can include an acoustic model 304, a language model 306, and/or a pronunciation dictionary 308, each of which is capable of extracting various audio features from an audio file. Each model may target different features of the audio file for extraction that, in combination, define a voice profile that is associated with the specific audio file.

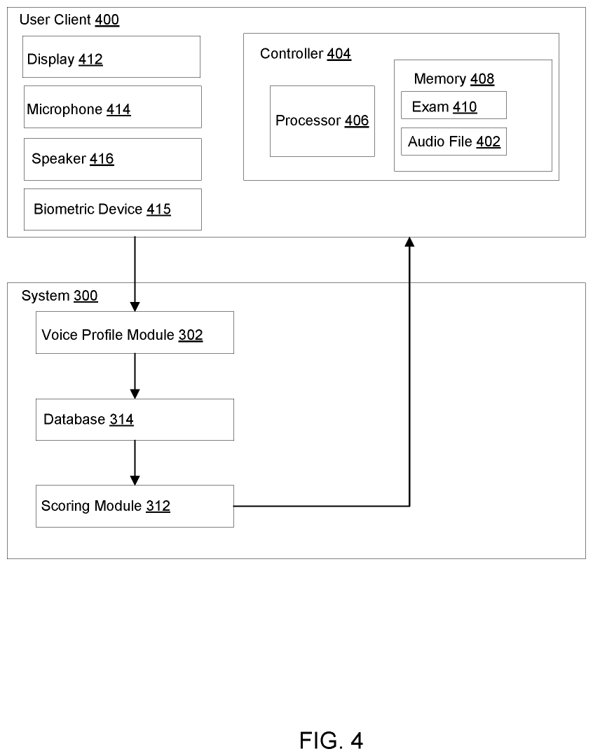

The acoustic model 304 is a repository of sounds—a probabilistic representation of variations of the sounds, or phones in English (or any other target language of interest for particular pronunciation assessments)—and various other acoustic features of a speaker's speech characteristics. During processing, each audio file 402 (FIG. 4) can be sliced into a speech signal of a small time frame (e.g., 10 milliseconds), and the model identifies the phonemes that were most likely pronounced in those slices of time. Those phonemes are then parsed into phoneme sequences that match actual words in the language. The word that is identified is the most likely match, often from among several possible options. Arriving at the most probable sequence of words by automatic speech recognition can be seen as a task of a series of probabilistic estimates, building from small time-frames, to phones, and then to words and word-strings.

The language model 306 represents a sequence of words that the speaker might be expected to say. It is a probability distribution over sequences of words, typically bigrams and trigrams (i.e., sequences of two or three words). For example, in describing a picture of a dining table, “knife and fork” or “salt and pepper” are trigrams that frequently occur in the English language and probably also occur frequently in the speech of learners performing that task. The language model 306 can be trained to anticipate these words, thereby improving recognition accuracy and the speed of speech recognition, because the search space is dramatically reduced. The language model 306 may be constructed for particular items based on some advance data collection that yields a set of frequently produced patterns. The language model 306 can also store various unique sequences of words in relation to various speakers, which may be helpful in determining a speaker based on these unique sequences of words.

In addition, the language model 306 may also consider various speech characteristics, such as pronunciation, prosody, fundamental frequency, and/or duration statistics.

Pronunciation is normally considered to consist of segmental features and suprasegmental features. Segmental features refer to sounds, such as consonants and vowels. Suprasegmental features include aspects of speech such as intonation, word and syllable stress, rhythm and sentence-level stress, and speed.

Prosody is used by speakers to convey information (questions or statements) and emotions (surprise or anger) as well as contextual clues (whether the speaker is conveying new or known information). Prosody normally refers to patterns of intonation, stress, and pausing. In speech processing, the measurable aspects of speech underlying these traits are fundamental frequency, energy, and duration statistics.

Fundamental frequency refers to the speaker's pitch patterns. Contours can be drawn to plot out rising or falling pitch and energy onset in word sequences. For example, saying a word or sentence with rising intonation would be illustrated by a rising line, or contour, on the plot. Similarly, saying a word with greater stress, or energy, is also illustrated by a rising contour on the plot. These plots help visualize the pattern of pitch or energy, and show how they change over the utterance, and how strong or weak they are over the course of the utterance.

Duration statistics such as the articulation time for a segment or intra- and inter-word silences are features of word stress and rhythm. The duration values in a candidate's speech can be compared to the parameters of duration values derived from a collection of the previous audio files from a common candidate. For example, the number of milliseconds of a pause at a particular comma or phrase boundary may be calculated based on previously analyzed audio files from that candidate and an average delay and standard deviation may be calculated. If the speaker pauses for a length of time outside these parameters, it may indicate that this speaker is not the same person as the designated candidate, thus, a proxy candidate.

The pronunciation dictionary 308 lists the most common pronunciations of the words in the language model 306. If certain words (e.g., “schedule”) are validly pronounced in more than one way, those different pronunciation variants may be listed for each of those words (e.g., /k/ vs. /sh/ for the “ch” sound in “schedule”), depending on the intended use of the system 300. Each of the various pronunciations may be correlated to a specific speaker.

The scoring module 310 compares the features audio files that are extracted by the voice profile module, and consequently, by any models therein, to calculate a confidence score using any practicable score-generation algorithm. This score-generation algorithm “learns” how to score the likelihood that two audio files were recorded from a common speaker through comparative analysis and predictions of similar features, which may be further refined through iterative comparative analysis of the features and weighting of various extracted features. The scoring module 310 may be the method for selecting features generated by the one or more models provided herein and applying them to predict or replicate human ratings. In some embodiments the scoring module 310 may be further configured to detect certain background noises in the received audio files that may be indicative of a likelihood of cheating and may adjust the scoring module 310's scores accordingly.

In some embodiments, additional data relating to the user's speech patterns can be provided to voice profile module 302 to further refine and enhance the voice analysis. For example, video data captured of a speaker while a particular audio file is being record may be utilized by voice profile module 302 to further refine its analysis of the audio file. For example, the video file may be processed to analyze facial movements (e.g., movements of the jaw or lips) corresponding to particular temporal periods of the audio record to facilitate analysis of the audio recording.

Training and implementing a scoring module 310 can have several steps. First, a relevant set of features for human scoring may be used. Second, relevant statistical models which will best handle the complex data to predict human scores are determined. For example, the statistical model can be linear regression, machine learning engines 312, or support vector machine regression.

Referring still to FIG. 3, in some embodiments, the scoring module 310 can be trained to analyze audio files and any other corresponding data and determine a confidence score that two audio files are from a common speaker. The confidence score is a computed probability that the speaker is a defined individual. The defined individual may be a candidate, in which a high confidence score means that the speaker's identity is likely to be who the candidate claims to be. In some instances, a high confidence score may alternatively be generated that the speaker is a proxy that is claiming to be someone other than their true identity. The system 300 is configured to assist in the prevention of proxies completing various tasks, such as exams, that are supposed to be completed by the candidate themselves. Other scores may also be determined from the audio file, such as an accuracy score and/or a relevancy score of the content in the audio file or the manner in which the speech is expressed and delivered.

In some embodiments, the scoring module 310 may analyze the audio files through a factor analysis model, wherein various factors have been taught, and possibly weighted, to the scoring module 310. In some examples, the system 300 inputs the audio files and the extracted features to a machine learning engine 312, which may, in some embodiments be implemented as a machine learning engine. The machine learning engine 312 has been trained and indicates likelihoods that audio files correspond to specific candidates when the audio files, extracted features, and/or additional information are provided. The machine learning engine 312 can produce machine learning engine outputs, which the system 300 uses to identify a candidate for the assessment audio file based on a candidate confidence score and/or a proxy confidence score. The machine learning engine 312 may be implemented in a number of different configurations. In an embodiment, for example, the machine learning engine 312 includes a first component configured to implement at least a portion of the functionality for processing inputted audio recordings and corresponding data files into a number of features, a second component configured to generate output confidence scores based upon the analysis of those features, and a third component configured to indicate a risk level associated with a particular candidate that may be utilized to trigger a follow-up investigation. In other embodiments, the machine learning engine 312 may be implemented by a different number of functional components or elements.

The system 300 may also include one or more databases 314. The database(s) 314 may store one or more data sets 316, 318, 320. Each data set 316, 318, 320 may include a plurality of audio files. In some examples, the various cataloged features may be stored in look-up tables within the data sets 316, 318, 320 to decrease the amount of time needed to find similar audio files and/or audio files from a common individual.

In the embodiment illustrated in FIG. 3, the database 314 includes three datasets. The first data set 316 includes audio files used as training data for the machine learning engine 312. The second data set 318 includes assessment audio files that are compiled from various candidates. Each candidate may have one or more audio files that are generated at various times and a single recorded assessment audio file may be separated into more than one audio file for generating additional data. In some examples, the candidate may record a first assessment audio file at a first time period, such as before an examination. A second recording (or multiple recordings) may be made during the examination at a predefined frequency or as necessary—as authentication for examination or as a portion of the examination. Or, the second recorded assessment audio file may be recorded after completion of the examination. The first and second recordings are both stored in the second data set 318 and used for generating a confidence score by the scoring module 310. As provided herein, a confidence score is generated based on the probability that the assessment audio file is from a candidate having a previously stored audio file and/or that the assessment audio file is not attributable to a known proxy.

In some embodiments, each new audio file may be analyzed by the voice profile module 302 to determine one or more features. In addition, the audio file may be compared to proxy audio files from known proxies that are stored in the third data set 320 or a proxy data set. In some instances, the assessment audio file is compared to the audio files of the known proxies when the confidence score of the candidate is below a first threshold. In other instances, each assessment audio file is compared to the audio files in both data sets contemporaneously.

The third data set 320 may also include other information regarding the known proxies and additional characteristics of the known proxies. For example, additional characteristics may include various physical traits (such as sex, approximate height, hair color, eye color, country or origin) or other data, such as, languages spoken, mouse cursor movement or keyboard typing characteristics, attributes of computer system being used by the individual, etc. and/or previous locations (or regions) of recordings from known proxies that may be helpful to an examination proctor in determining whether a proxy is attempting to participate in an examination. It will be appreciated that all information regarding the candidates and proxies may be stored within one or more data sets 316, 318, 320 or organized in any other manner.

Referring to FIG. 4, a user client device 400 may be used to record and/or receive an audio file 402 and may be any one of a variety of computing devices and may include a controller 404 having a processor 406 and memory 408. The memory 408 may store logic having one or more routines or program instructions that is executable by the processor 406. In addition, the routines may include an exam routine for administering a routine 410, an audio file recording routine, and/or a notification producing routine.

In various embodiments, the user client device 400 may be a computer, cell phone, mobile communication device, key fob, wearable device (e.g., fitness band, watch, glasses, jewelry, wallet), apparel (e.g., a tee shirt, gloves, shoes or other accessories), personal digital assistant, headphones and/or other devices that include capabilities for wireless communications and/or any wired communications protocols. The user client device 400 may include a display 412 that provides a graphical user interface (GUI) and/or various types of information to a user. The electronic device may include a microphone 414 and/or a speaker 416 that may be capable of accepting and replaying audio files 402, respectively. In addition, the user client device 400 may be controlled through various uses of the microphone and/or the speaker. The user client device 400 may have any combination of software and/or processing circuitry suitable for controlling the user client device 400 described herein including without limitation processors, microcontrollers, application-specific integrated circuits, programmable gate arrays, and any other digital and/or analog components, as well as combinations of the foregoing, along with inputs and outputs for transceiving control signals, drive signals, power signals, sensor signals, and so forth. In embodiments, the user client 400 may include additional biometric capture devices 415 configured to capture biometric data associated with a user of user client 400. Biometric capture devices 415 may be configured to capture biometric data such as fingerprint, palm vein, or iris scan data, or other types of biometric data, such as video (e.g., infrared or conventional) of a user.

The user client device 400 may transmit the audio file 402 and any corresponding data (e.g., video or other biometric data) to the system 300. The transmission may occur through one or more of any desired combination of wired (e.g., cable and fiber) and/or wireless communication mechanisms and any desired network topology (or topologies when multiple communication mechanisms are utilized). Exemplary wireless communication networks include a wireless transceiver (e.g., a BLUETOOTH module, a ZIGBEE transceiver, a Wi-Fi transceiver, an IrDA transceiver, an RFID transceiver, etc.), local area networks (LAN), and/or wide area networks (WAN), including the Internet, cellular, satellite, microwave, and radio frequency, providing data communication services.

The system 300, having received the audio file 402 and, optionally, additional corresponding data from the user client device 400, may use the voice profile module 302 to parse and profile the assessment audio file 402 based on one or more features. As non-limiting examples, the features may be any of the previously described characteristics of human speech. In some examples, the voice profile module 302 may utilize a weighted machine learning engine 312 to determine the likelihood that various features are recorded from a common speaker. Once various characteristics of the audio file 402 are determined, the audio file 402 may be stored in the database 314.

The system 300 may then determine an identity confidence score for the audio file 402 through use of the scoring module 310. In use, the scoring module 310 may compare features of the assessment audio file 402 to features of the previously profiled audio files within the database 314. Based on the detected features, the scoring module 310 may calculate the likelihood that the assessment audio file 402 is from a common speaker as a previously stored audio file. The identity confidence score may be in the form of a candidate confidence score and/or a proxy confidence score.

In some examples, a candidate submits a first audio file 402 when applying for an examination. The first audio file 402 may be provided, for example, in a controlled environment that is overseen directly by a proctor and coincides with the candidate providing proof of identify (e.g., photo identification or biometric identification.) Accordingly, the first audio file 402 may be a “known0-good” recording of the candidate's voice. When the candidate appears for the examination, a second audio file 402 is recorded (e.g., during the examination) and the system 300 outputs the candidate confidence score and/or the proxy confidence score to the user client device 400. In some embodiments, if a candidate confidence score is above a first threshold, a pass notification may be provided through the system 300 and/or the user client device 400. When the candidate confidence score is below the first threshold, the score may be compared to known proxies to predict an identity of the speaker. If the candidate confidence score is below a second threshold, the system 300 may automatically generate a fail notification. In addition, when the candidate confidence score is below the second threshold, the audio file 402 may or may not be compared to the proxy confidence score. In instances where the proxy confidence score is greater than the candidate confidence score and/or the candidate confidence score is below the second threshold, the candidate may be barred from receiving their test results.

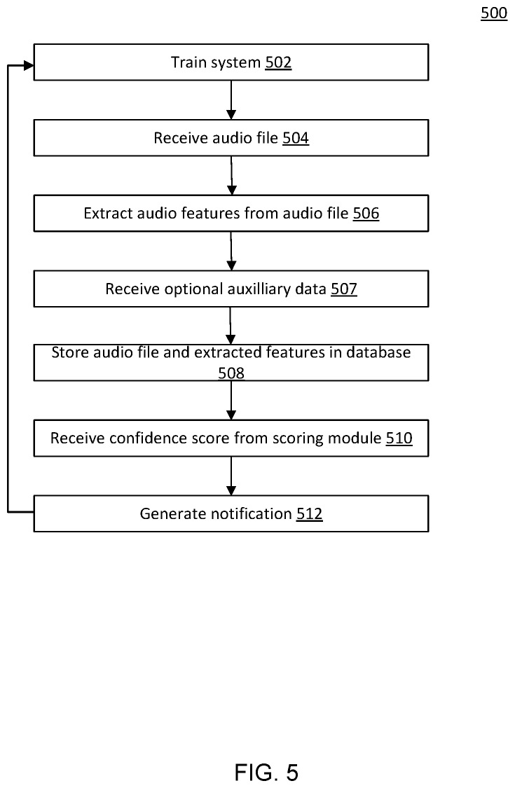

Referring to FIG. 5, a method 500 of determining a candidate confidence score and/or a proxy confidence score is illustrated, according to some embodiments. In the illustrated embodiment, the method begins at step 502 where the voice profile module 302 and scoring module 312 are each trained. For example, the voice profile module 302 (FIG. 3) may be trained to parse audio features during a different portion or window of the assessment audio file 402. The scoring module 312 may be trained to calculate one or more confidence scores.

Next, at step 504, the system 300 receives an assessment audio file 402 (FIG. 4), which may be provided through the user client device 400. As provided herein, the assessment audio file 402 may be recorded prior to, during, and/or after an examination. In some embodiments, an examination may include a verbal section that scores a candidate's speaking proficiency, which is recorded for scoring the proficiency thereof. This verbal section of the exam may be recorded and then used to compare the audio files to previous exam registrations of a common candidate and/or other candidates' audio files. The previous audio files may be recorded from the speaker during the examination at a predefined interval (e.g., a new recording is stored every minute during the examination). In some instances, the candidate confidence score and proxy confidence score are calculated contemporaneously with the speaking proficiency examination.

At step 506, the assessment audio file 402 is analyzed and a plurality of features and/or variables are extracted from the file. At step 508, the assessment audio file 402 and the extracted features are stored in a database 314 (FIG. 3).

At step 507, the system 300 may receive additional auxiliary data that may be utilized to calculate a candidate confidence score and/or a proxy confidence score. For example, the auxiliary data may include video data captured of the candidate at the time the assessment audio file 402 was captured. In that case, the video data may be utilized to facilitate the analysis of the audio content itself (e.g., by tracking jaw or lip movement that may be used to better process the content of the audio file 402). Or, alternatively, the video file may be utilized to determine alternative attributes of the candidate that may operate as a weighting value that may modify the candidate confidence score. For example, the video data may be analyzed to determine a mood of the candidate. If the analysis indicates that the candidate is nervous (or exhibiting an unusually high degree of confidence), which, in turn, indicates an increased likelihood of cheating, the candidate confidence score may be weighted downwards correspondingly to reflect the increased risk of cheating. In analyzing the mood of the candidate, comparison of the candidate's mood to the mood of the general population taking the same exam may be used to identify candidates having outlier moods.

In other embodiments, in step 507 the system 300 may receive additional attributes describing the candidate that may be utilized in conjunction with the analysis of the assessment audio file 402 to calculate a candidate confidence score and/or a proxy confidence score. For example, biographical information such as the age, sex, country of origin of the candidate, or a list of spoken languages of the candidate may be used to analyze the audio file 402. With knowledge of the candidate's country of origin or known spoken languages, the machine learning engine that processes the assessment audio file 402 can utilize acoustic models 304, language models 306, and pronunciation dictionaries 308 that are associated with the candidate's country of origin or known spoken languages. The candidate's age or sex may be utilized in the analysis of the auxiliary data and the assessment audio file 402 to confirm that attributes of the voice captured in the assessment audio file 402 are consistent with the age and sex of the candidate.

In still other embodiments, in step 507 the system 300 may receive additional information describing attributes of the candidate's computer system that is being used to undertake an examination activity. Such information may include details describing the computer hardware (e.g., media access control address, microphone serials numbers, and the like) or how the candidate is interacting with the hardware (e.g., keystroke interactions—including keystroke frequency, mouse cursor movement attributes). Such information can be analyzed to determine whether the computer hardware being utilized by the candidate is approved and whether the candidate's interactions with the hardware are indicative of suspect activity. If so, the system may weight the calculated candidate confidence score and/or proxy confidence to indicate that increased risk of suspect activity.

At step 510, a candidate confidence score and/or a proxy confidence score may be computed by the scoring module 310. Each of these scores may be a measure of the probability that the assessment audio file 402 is the identity of the candidate or a proxy that is posing as someone of another identity. Once the confidence scores are calculated, the scores are provided to the user client device 400 and/or any other electronic device and a notification is generated at step 512. Following the completion of step 512, the method may return to step 502 where the outputs generated in steps 510 and/or 512 may be fed back into the system so as to continue the training of the system 300.

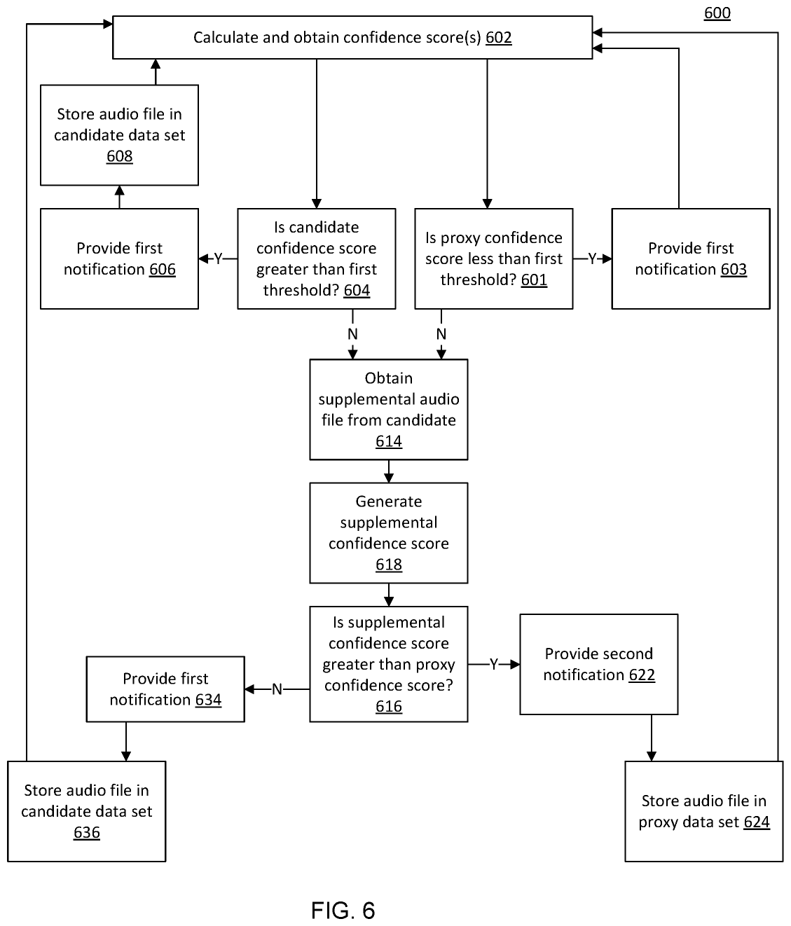

Referring to FIG. 6, a method 600 of generating first (e.g., pass) or second (e.g., fail) notifications based on the computed confidence scores is illustrated, according to some embodiments. As illustrated, the method starts at step 602 where the candidate confidence score and a proxy confidence score are calculated and/or obtained following receipt of an audio file. The confidence scores may be obtained in any manner, including via audio file features extraction, as described in reference to FIG. 5. The confidence score is a probability that two audio files are recorded from a common speaker that is calculated using any practicable score-generation algorithm and may, as described herein, be weighted to reflect other determined factors that may be indicative of potential cheating or suspect behavior. For example, if auxiliary information (e.g., the data transmitted to system 300 in step 507 of the method of FIG. 5) indicates a likelihood of suspect activity, one or more of the candidate confidence score and the proxy confidence score may be adjusted (e.g., decreased) to account for that indication of risk. The score-generation algorithm “learns” how to score the likelihood that two audio files were recorded from a common speaker through comparative analysis and predictions of similar features, which may be further refined through iterative comparative analysis of the features and weighting of various extracted features and implemented through a machine learning engine. The scoring module may output a candidate confidence score, a proxy confidence score, and/or any other type of confidence score. In an embodiment, each confidence score is a representative probability quantified as a number between 0 and 1 in which 0 indicates impossibility and 1 indicates certainty that two audio files were recorded from a common speaker, though in other embodiments the confidence score may be represented by other numeric or non-numeric values. The higher the confidence score, or probability, the more likely that two audio files are from a common speaker.

The system may include predefined thresholds for determining whether a confidence score is high enough to deem that the two audio files are from a common speaker. For example, a first predefined threshold of 0.8 indicating a predicted 80% probability that the two audio files are from a common speaker may be set. A second threshold of 0.6 may be defined indicating a less likely chance that the two audio files are from a common speaker. Once the scoring module generates the various confidence scores, the confidence scores may be compared to the thresholds to dictate which scores generate a pass notification indicating the two files are from a common speaker or a fail notification indicating that the likelihood of a common speaker between two audio files is below a predefined probability. Any number of thresholds may be defined at any probability for determining when to generate a pass or a fail notification. In the illustrated example of FIG. 6, if the candidate confidence score is above a first threshold at step 604 indicating a likelihood that an assessment audio file 402 is from a specific candidate, a first, or pass, notification may be provided at step 606. The pass notification may indicate that the system has determined that the candidate taking the exam has been properly identified. The pass notification, once generated, may stop the analysis of captured audio data during a testing event. In other embodiments, the generation of a pass notification may instead reduce the frequency with which audio data is captured from that candidate for the purpose of confirming the candidate's identity or audio file monitoring may simply continue. Once the first notification is provided, the assessment audio file and extracted features are stored within a candidate data set at step 608. The method may then optionally return to step 602 to continue processing captured audio files.

At the same time or approximately the same time, the audio data captured during step 602 may be evaluated to determine whether the candidate is a proxy test taker. According, if the proxy confidence score is less than the first threshold at step 601 indicating a likelihood that the candidate is not a proxy, the first, or pass, notification may be provided at step 603 and the method may return to step 602 to continue processing captured audio files.

If the outcome of either evaluation step 604 or 601 is negative (indicating a risk that the candidates identity has not been confirmed of the candidate may be a proxy), the method moves to step 614 to captured additional audio data of the candidate and perform additional analysis of that captured audio. Accordingly, at step 614, an additional audio file 402 from the candidate may be obtained and the second audio file may be compared to the first audio file 402 and/or any other audio file 402 from the known candidate. As provided herein, the second audio file may be recorded during a common examination as the first audio file and/or at any other time. At step 618, a supplemental candidate confidence score may be generated accordingly to the methods described herein. At step 616, the supplemental candidate confidence score may be compared to the proxy confidence score generated in step 602 (or, alternatively, to a predefined threshold value). For instance, when the supplemental confidence score and the proxy confidence score are compared to one another, a notification of the greater score may be outputted to a user client device. In instances in which the supplemental confidence score is higher than the proxy confidence score, it is more likely that the assessment audio file is recorded from a candidate. In instances in which the proxy confidence score is greater than a candidate confidence score, it is more likely that the assessment audio file is not recorded from the person claiming to be the candidate. In some examples, when the supplemental confidence score is greater than the proxy confidence score a first notification, such as a pass or confirmation notification, is provided to the user client device and/or system 300.

Accordingly if, in step 616, the supplemental candidate confidence score is greater than the proxy confidence score, the first notification may be provided by the system 300 at step 634 and the assessment audio file and extracted features may be stored at step 636. The method may then then return to step 602 to continue processing captured audio files.

If in step 616, the proxy confidence score is greater than the supplemental confidence score, the method 600 may proceed to step 622 where the second notification is generated. The second notification may be a notification generated to system 300 indicating that the candidate is a likely proxy. In that case, the testing event may be interrupted or the testing event may be flagged for further follow-up and analysis (e.g., by a human proctor or investigator). Alternatively, in some embodiments, the second notification may be generated at the user client device and may therefore operate as a warning to the user of the apparent discrepancy thereby allowing the user to take appropriate mitigating action (e.g., to speak more clearly into the microphone, enable additional monitoring (e.g., via video) of the candidate or the like). After providing the second notification, in step 624 the assessment audio file and extracted features may be stored for later review and analysis. The method may then return to step 602 to continue processing captured audio files.

In instances in which the second notification is provided at step 622, the second notification may be provided to a user client and any physical characteristics of the proxy may be added to the third data set 320. The location and physical characteristics may be used to further refine the confidence scores of candidates and proxies. In addition, in further comparisons, when the probability that an audio file is from a proxy as determined by having a calculated probability above a predefined metric, the location and physical characteristics can also be used to further confirm that the speaker is in fact the proxy.

In addition, the system may provide the basis for supplying the second, or fail, notification. For instance, the second notification may be generated by step 622. Accordingly, the notification may include which comparison or threshold led to the second notification output. Further, any other desired information may additionally or alternatively be output to the user client regarding any method 500, 600 provided herein.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A system comprising at least one processor executing program code instructions on a server computer coupled to a network, the program code instructions causing the server computer to:
receive from a user client device an assessment audio file;
extract a plurality of audio features from the assessment audio file using a voice profile module, wherein the audio features are extracted through at least one of an acoustic model, a language model, and a pronunciation dictionary;
store the assessment audio file and extracted features in a database;
calculate, through a scoring module, a candidate confidence score indicating a probability that the assessment audio file is from a common speaker as a previously stored audio file within the database; and
generate a first notification when the candidate confidence score is above a first threshold or a second notification when the candidate confidence score is less than a second threshold, wherein the first and second thresholds are predefined probability metrics and the second threshold is lower than the first threshold.

2. The system of claim 1, wherein the program code instructions further cause the server computer to:
train the scoring module on a plurality of different data sets to create a corresponding weighted machine learning engine.

3. The system of claim 1, wherein the program code instructions further cause the server computer to:
store the assessment audio file and extracted features from the assessment audio file in one or more data sets.

4. The system of claim 3, wherein the program code instructions further cause the server computer to:
store candidate audio files in a first data set of the one or more data sets;
store proxy audio files in a second data set of the one or more data sets, wherein a proxy audio file is recorded from a speaker previously deemed a proxy;
calculate a proxy confidence score of the assessment audio file to at least one proxy audio file from the scoring module indicating a likelihood that the assessment audio file was recorded by a speaker deemed a proxy;
compare the candidate confidence score to the proxy confidence score when the candidate confidence score is between the first and second thresholds; and
generate the second notification if the proxy confidence score is greater than the candidate confidence score.

5. The system of claim 1, wherein the database includes a first data set containing training data, a second data set containing previously recorded candidate audio files, and a third data set containing proxy audio files.

6. The system of claim 1, wherein the program code instructions further cause the server computer to:
receive from the user client device at least one of a location of recording and an attribute of the speaker of the assessment audio file, wherein the attribute may include an age of the speaker or a spoken language of the speaker; and
store at least one of the location of recording and attribute of the speaker with each audio file in the database.

7. The system of claim 6, wherein the assessment audio file is recorded during a verbal examination and at least one additional audio file is stored by the candidate prior to the verbal examination.

8. A method for at least one processor executing program code instructions on a server computer coupled to a network, comprising the steps of:
receiving an assessment audio file from a user client device;
determining a plurality of features from the assessment audio file through a voice profile module;
applying the features to a scoring module comprising a machine learning engine to calculate a candidate confidence score indicating a probability that two audio files are recorded from a common speaker and a proxy confidence score indicating a probability that the two audio files are from two different speakers;
comparing the candidate confidence score to a first threshold and a second threshold, wherein the first and second thresholds are predefined probability metrics; and
generating a first notification when the candidate confidence score is greater than the first threshold and a second notification when the candidate confidence score is less than the second threshold.

9. The method of claim 8, wherein the generating the first or second notification step further comprises:
generating the first notification when the candidate confidence score is greater than the proxy confidence score; and
generating the second notification when the proxy confidence score is greater than the candidate confidence score.

10. The method of claim 9, further comprising the step of:
comparing the candidate confidence score to the proxy confidence score when the candidate confidence score is between the first and second thresholds.

11. The method of claim 9, further comprising the step of:
displaying the first notification or the second notification on a display of the user client device.

12. The method of claim 8, further comprising the steps of:
requesting, through the user client device, a supplemental audio file from a candidate when the candidate confidence score is below the first threshold.

13. The method of claim 12, further comprising the step of:
receiving from the scoring module a supplemental confidence score indicating the probability that the assessment audio file and the supplemental audio file are from a common speaker; and
generating a pass notification when the supplemental confidence score is greater than a third threshold, the third threshold configured as a predefined allowable probability.

14. The method of claim 13, further comprising the steps of, before receiving from the scoring module the supplemental confidence score:
determining a second plurality of features from the supplemental audio file through a voice profile module; and
transmitting the second plurality of features to the scoring module.

15. A system, comprising:
a processor; and
a memory coupled to the processor, wherein the memory stores program instructions executable by the processor to perform:
receiving an assessment audio file;
determining a plurality of features from the assessment audio file through a voice profile module;
applying the features to a scoring module;
receiving from the scoring module a candidate confidence score and a proxy confidence score; and
storing the assessment audio file in a proxy data set when the candidate confidence score is below a proxy threshold.

16. The system of claim 15, wherein the processor is further configured to perform the step of:
providing a fail notification to a user client device when the candidate confidence score is below a proxy threshold.

17. The system of claim 15, wherein the processor is further configured to perform the step of:
storing characteristics with the assessment audio file when the candidate confidence score is below a proxy threshold, the characteristics including a recording location of the assessment audio file.

18. The system of claim 15, wherein the scoring module includes a machine learning engine that is trained by a first data set of audio files stored within a database, the database also containing a second data set of assessment audio files of previous candidates and a third data set of audio files of known proxies.

19. The system of claim 15, wherein the processor is further configured to perform:
displaying a pass notification on a user client device when the candidate confidence score is above a first threshold indicating that a probability of a common speaker between the assessment audio file and at least one other stored audio file is greater than a predefined probability metric.

20. The system of claim 15, wherein the candidate confidence score and proxy confidence score are calculated contemporaneously with a speaking proficiency examination.
